(19) United States
(12) Patent Application Publication
(10) Pub. No.: US 2024/0221525 A1
(43) Pub. Date: Jul. 4, 2024

(54) CONTENT OUTPUT METHOD AND APPARATUS, COMPUTER-READABLE MEDIUM, AND ELECTRONIC DEVICE

(71) Applicant: BEIJING YOUZHUJU NETWORK TECHNOLOGY CO., LTD., Beijing (CN)

(72) Inventors: Shujun DENG, Beijing (CN); Yanxin KAN, Beijing (CN); Wenyu NIE, Beijing (CN)

(21) Appl. No.: 18/253,262

(22) PCT Filed: Dec. 14, 2022
(86) PCT No.: PCT/CN2022/138907

§ 371 Date: Jul. 6, 2023

(30) Foreign Application Priority Data
Dec. 27, 2021 (CN) 202111619517.5

(51) Int. Cl. G09B 7/00; G06F 16/9535

(52) U.S. Cl. CPC G09B 7/00; G06F 16/9535

(57) ABSTRACT

Provided are a content output method and apparatus, a computer-readable medium, and an electronic device. The method includes: obtaining information of each of candidate content items for a user; predicting, based on the information of each of the candidate content items by invoking a pre-trained content recommendation model, an expected benefit for each of the candidate content items resulting from a user's operation on each of the candidate content items, in which the pre-trained content recommendation model is trained historical data of the user, and the historical data includes an actual benefit resulting from a user's operation on a historical content item and information of the historical content item; and outputting a first content item based on the expected benefit for each of the candidate content items.

### CROSS-REFERENCE TO RELATED APPLICATIONS

The present application claims priority to Chinese Patent Application No. 202111619517.5, titled “CONTENT OUTPUT METHOD AND APPARATUS, COMPUTER-READABLE MEDIUM, AND ELECTRONIC DEVICE”, filed on Dec. 27, 2021, the entire content of which is incorporated herein by reference.

### FIELD

The present disclosure relates to the field of computer science, and more particularly, to a content output method and apparatus, a computer-readable medium, and an electronic device.

### BACKGROUND

The self-adaptive recommendation is one of the most important links in personalized learning products, and a most suitable learning scheme and learning materials are customized for a user by analyzing historical learning condition of the user. During user's learning, the maximization of a learning effect or learning efficiency is often desired. That is, knowledge level or ability level of the user is desired to be improved to the maximum extent in a shortest time. The related recommendation methods are often lacking of flexibility cannot adapt to different individual adaptability, for example, recommending questions with fixed accuracy rate for each user.

### SUMMARY

The SUMMARY is provided to introduce in brief the concepts which will be described in detail later in the Detailed Description. This content is not intended to identify key or necessary features of the claimed technical solution, nor is it intended to limit the scope of the claimed technical solution.

According to one or more embodiments of the present disclosure, there is provided a content output method including: obtaining information of each of candidate content items for a user; predicting, based on the information of each of the candidate content items by invoking a pre-trained content recommendation model, an expected benefit for each of the candidate content items resulting from a user's operation on each of the candidate content items, in which the pre-trained content recommendation model is trained by historical data of the user, and the historical data includes an actual benefit resulting from a user's operation on a historical content item, information of the historical content item, and capability attribute information of the user; and outputting a first content item based on the expected benefit for each of the candidate content items.

According to one or more embodiments of the present disclosure, there is provided a content output apparatus including: an obtaining module configured to obtain information of each of candidate content items for a user; a processing module configured to predict, based on the information of each of the candidate content items by invoking a pre-trained content recommendation model, an expected benefit for each of the candidate content items resulting from a user's operation on each of the candidate content items, in which the pre-trained content recommendation model is trained by historical data of the user, and the historical data incudes an actual benefit resulting from a user's operation on a historical content item, information of the historical content item, and capability attribute information of the user; and an output module configured to output a first content item based on the expected benefit for each of the candidate content items.

According to one or more embodiments of the present disclosure, there is provided a computer-readable medium, having a computer program stored thereon, in which the computer program, when executed by a processor, implements operations of the content output method as described in the above embodiments.

According to one or more embodiments of the present disclosure, there is provided an electronic device including a memory having a computer program stored thereon; and a processor configured to execute the computer program stored on the memory to implement operations of the content output method as described in the above embodiments.

According to the technical solution, the information of each of the candidate content items for the user is obtained. The expected benefit for each of the candidate content items resulting from the user's operation on each of the candidate content items is predicted based on the information of each of the candidate content items by invoking the pre-trained content recommendation model. The pre-trained content recommendation model is trained historical data of the user, and the historical data includes the actual benefit resulting from the user's operation on the historical content item, the information of the historical content item, and the capability attribute information of the user. The first content item is output based on the expected benefit for each of the candidate content items. When recommending content items to the user, the historical benefit for different users to each content item and the attribute of each content item are considered, the most suitable learning items are recommended to different users, which can maximize learning effect or learning efficiency and the knowledge level of the users in the shortest possible time.

Other features and advantages of the present disclosure will be described in detail in the Detailed Description.

### BRIEF DESCRIPTION OF THE DRAWINGS

Embodiments of the present disclosure will become more apparent in conjunction with the accompanying drawings. Throughout the drawings, same or similar elements are denoted by same or similar reference numerals. It should be understood that the drawings are schematic, and elements and components are not necessarily drawn to scale.

FIG. 1 is a schematic structural diagram of a computer system according to an exemplary embodiment of the present disclosure.

FIG. 2 is a flowchart of a content output method according to an exemplary embodiment of the present disclosure.

FIG. 3 is a flowchart of operations at sub-blocks of block S102 according to an exemplary embodiment of the present disclosure.

FIG. 4 is a flowchart of another content output method according to an exemplary embodiment of the present disclosure.

FIG. 5 is a block diagram of a content output apparatus according to an exemplary embodiment of the present disclosure.

FIG. 6 is a schematic structural diagram of an electronic device according to an exemplary embodiment of the present disclosure.

### REFERENCE NUMBERS

120—terminal; 140—server; 20—content output apparatus; 201—obtaining module; 203—processing module; 205—output module; 600—electronic device; 601—processing device; 602—ROM; 603—RAM; 604—bus; 605—I/O interface; 606—input device; 607—output device; 608—storage device; and 609—communication device.

### DETAILED DESCRIPTION

Embodiments of the present disclosure will be described in detail below with reference to the accompanying drawings. Although some embodiments of the present disclosure are illustrated in the drawings, it should be understood that the present disclosure may be embodied in various forms and should not be construed as being limited to the embodiments set forth herein. Instead, these embodiments are provided for a complete and thorough understanding of the present disclosure. It should be understood that the drawings and embodiments of the present disclosure are only used for exemplary purposes, rather than to limit the protection scope of the present disclosure.

It should be understood that steps described in the method embodiments of the present disclosure may be executed in different sequences and/or in parallel. In addition, method implementations may include additional steps and/or omit executions of the illustrated steps. The scope of the present disclosure is not limited in this respect.

The term “include” and its variants as used herein indicate open-ended inclusions, i.e., “includes but not limited to”. The term “based on” refers to “at least partially based on”. Relevant definitions of other terms will be given in the following description.

It should be noted that concepts such as “first” and “second” mentioned in the present disclosure are merely used to distinguish different devices, modules or units, rather than to limit a sequence or interdependence of functions performed by these device, modules or units.

Names of messages or information exchanged between devices in the embodiments of the present disclosure are merely for illustrative purposes, rather than limiting the scope of these messages or information.

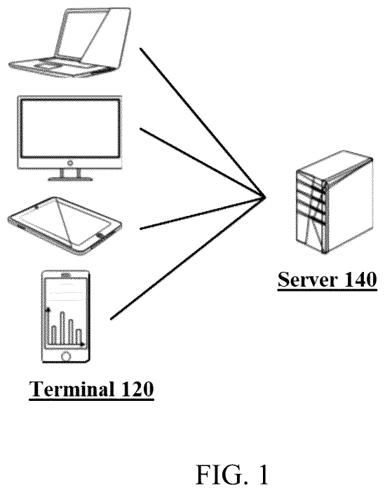

FIG. 1 is a schematic structural diagram of a computer system according to an exemplary embodiment of the present disclosure. The computer system includes a terminal 120 and a server 140.

The terminal 120 and the server 140 are connected to each other through a wired or wireless network.

The terminal 120 may include at least one of a smart phone, a notebook computer, a desktop computer, a tablet, a smart speaker, and an intelligent robot.

The terminal 120 includes a display. The display is configured to display a first content item or a second content item recommended to a user.

The terminal 120 includes a first memory and a first processor. The first memory has a first program stored thereon. The first program is invoked and executed by the first processor to implement a training method of a corpus classification model or a corpus classification method. The first memory may include, but is not limited to, a Random Access Memory (RAM), a Read Only Memory (ROM), a Programmable Read-Only Memory (PROM), an Erasable Programmable Read-Only Memory (EPROM), and an Electric Erasable Programmable Read-Only Memory (EEPROM).

The first processor may be composed of one or more integrated circuit chips. In some embodiments, the first processor may be a general purpose processor, such as a Central Processing Unit (CPU) or a Network Processor (NP). In some embodiments, the first processor can implement the content output method according to the embodiments of the present disclosure by invoking a pre-trained content recommendation model. Exemplarily, the trained content recommendation model in the terminal may be obtained through training by the terminal or the server, or obtained by the terminal from the server.

The server 140 includes a second memory and a second processor. The second memory has a second program stored thereon. The second program is invoked by the second processor to implement the content output method according to the embodiments of the present disclosure. Exemplarily, the second memory has a pre-trained content recommendation model stored thereon, and the pre-trained content recommendation model is invoked by the second processor to implement the content output method. In some embodiments, the second memory may include, but is not limited to, a RAM, a ROM, a PROM, an EPROM, or an EEPROM. In some embodiments, the second processor may be a general purpose processor such as a CPU or an NP.

The server may be a stand-alone physical server, or a server cluster or a distributed system composed of multiple physical servers. The server may also be a cloud server for providing basic cloud computing service such as cloud service, cloud database, cloud computing, cloud function, cloud storage, network service, cloud communication, middleware service, domain name service, security service, CDN (Content Delivery Network), and big data and artificial intelligence platform. The terminals may be a smart phone, a tablet, a laptop, a desktop computer, a smart speaker, a smart watch, etc., and is not limited thereto. The terminal and the server may be connected to each other directly or indirectly via a wired or wireless communication, which is not limited herein.

Schematically, the content output method according to some embodiments of the present disclosure may be used in the field of education. For example, when a user answers a question, another question would be recommended to the user.

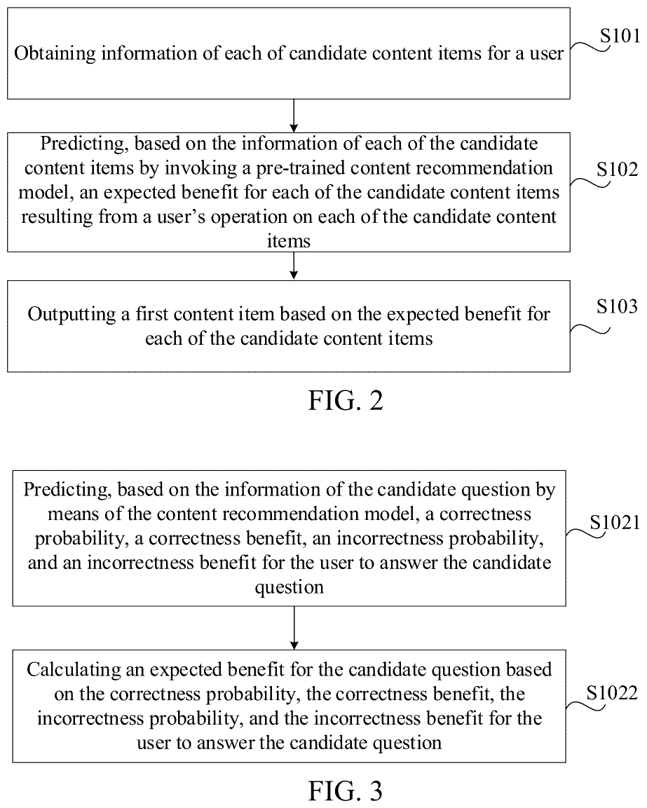

FIG. 2 is a flowchart of a content output method according to an exemplary embodiment of the present disclosure. The method is performed by a computer device, for example by the terminal or the server of the computer system shown in FIG. 1. The content output method shown in FIG. 2 includes operations at blocks S101 to S103.

At block S101, information of each of candidate content items for a user is obtained.

The candidate content items may be, but not limited to, candidate questions in a candidate question bank when the user makes a question on the terminal. In the present disclosure, the candidate question will be described below as an example of the candidate content items.

The information of the candidate content item is information of the candidate question. The information of the candidate question includes question difficulty, time intensity, question content, and a predetermined question benefit. The time intensity may be a duration required for the user to answer the question. For example, the time intensity may be an average duration for a plurality of users to answer the question correctly. The question content may be subject information of the question and information of field to which a specific subject belongs. For example, an English subject includes questions of a grammar section, questions of a word memory section, questions of preposition usage, and the like. The predetermined question benefit includes a predetermined correctness benefit and a predetermined incorrectness benefit. The correctness benefit is learning effect benefit when the user answers the question correctly. For example, the correctness benefit may be an improvement value of knowledge level or ability level. The incorrectness benefit is learning effect benefit when the user answers the question incorrectly. For example, the incorrect benefit may be a decline value of the knowledge level or the ability level.

At block S102, an expected benefit for each of the candidate content items resulting from a user's operation on each of the candidate content items is predicted based on the information of each of the candidate content items by invoking a pre-trained content recommendation model.

The pre-trained content recommendation model is trained historical data provided by the user. The historical data includes an actual benefit resulting from a user's operation on a historical content item, information of the historical content item, and capability attribute information of the user. The actual benefit includes a result of the user answering the question, such as a correct or incorrect result. The information of the historical content item includes the question difficulty, the time intensity, the question content, and the predetermined question benefit. The capability attribute information of the user includes existing ability of the user and a speed of answering the question. The existing ability may be mastery level of the user for specific question content, such as mastery level of the user for the grammar or vocabulary of the English subject.

Exemplary, the content recommendation model may be, but not limited to, a dynamic updating module and/or a Knowledge Tracing (KT) module of Item Response Theory (IRT), or other feasible models, which are not limited in the present disclosure.

The expected benefit for each of the candidate content items resulting from the user's operation on each of the candidate content items is predicted based on the question difficulty, the time intensity, the question content, and the predetermined question benefit by invoking the pre-trained content recommendation model.

It should be noted that the block S102 includes a sub-block S1021 and a sub-block S1022. The prediction of the expected benefit resulting from the user's operation on each candidate content item will be described in detail at the sub-blocks of the block S102. Reference will be made to FIG. 3, which is a flowchart of sub-blocks of the block S102 according to an exemplary embodiment of the present disclosure.

At sub-blocks 1021, a correctness probability, a correctness benefit, an incorrectness probability, and an incorrectness benefit for the user to answer the candidate question are predicted based on the information of the candidate question by means of the content recommendation model.

In an embodiment, the content recommendation model is composed of a knowledge tracking model and a learning effect evaluation model. The knowledge tracking model is used to predict the correctness probability or the incorrectness probability for the user to answer the candidate question, and the learning effect evaluation model is used to predict the correctness benefit or the incorrectness benefit for the user to answer the candidate question.

At sub-block S1022, an expected benefit for the candidate question is calculated based on the correctness probability, the correctness benefit, the incorrectness probability, and the incorrectness benefit for the user to answer the candidate question.

Exemplarily, the correctness benefit may be a positive value, and the incorrectness benefit may be a negative value. The expected benefit for the candidate question may be calculated according to:

$$G 1 = P 1 \times G 11 + ( 1 - P 1 ) \times G 10 , and$$

$$G 2 = P 2 \times G 21 + ( 1 - P 2 ) \times G 20 ,$$

where G1 represents an expected benefit for the user to answer a candidate question 1, P1 represents a correctness probability for the user to answer the candidate question 1, (1−P1) represents an incorrectness probability for the user to answer the candidate question, G11 represents a correctness benefit for the user to answer the candidate question 1, G10 represents an incorrectness benefit for the user to answer the candidate question 1; G2 represents an expected benefit for the user to answer a candidate question 2, P2 represents a correctness probability for the user to answer the candidate question 2, (1−P2) represents an incorrectness probability for the user to answer the candidate question 2, G21 represents a correctness benefit for the user to answer the candidate question 2, and G20 represents an incorrectness benefit for the user to answer the candidate question 2.

At block S103, the first content item is output based on the expected benefit for each of the candidate content items.

The candidate content items are ordered based on the expected benefit to determine a candidate content item with a greatest expected benefit among the candidate content items as the first content item, and then the first content item is output. It can be understood that the outputting of the first content item may be an outputting to the terminal corresponding to the user to recommend the first content item to the user. Exemplarily, assuming that G2>G1, the candidate question 2 is preferentially recommended to the user instead of the candidate question 1. When a corresponding operation is performed on the first content item by the user, after the first content item is completed, the candidate content items are ordered in a decreasing order of the expected benefits, and sequentially determined as the next first content item, and this first content item is recommended to the user. This operation is repeated until the first content item is completed by the user. Thereafter, the remaining candidate content items are ordered in a decreasing order of the expected benefits, and sequentially determined as the next first content item, and this first content item is recommended to the user.

In addition, the duration for the user to answer the question should be considered when the first content item is recommended to the user based on the expected benefit for each candidate content item. In one embodiment, an operating duration required for the user to operate each of the candidate content items is obtained. That is, the duration required for the user to correctly answer the candidate question is predicted by the content recommendation model based on the existing ability of the user, the speed of answering the question, and the information of the candidate question. An expected benefit rate of each of the candidate content items is obtained based on the expected benefit for each of the candidate content items and the operating duration for each of the candidate content items. A candidate content item with a greatest expected benefit rate among the candidate content item is determined as the first content item. The first content item is recommended to the user.

The expected benefit rate is the expected benefit for the candidate content item divided by time to obtain an expected benefit per unit time. The candidate content item with the greatest expected benefit per unit time is the candidate content item with the highest learning efficiency.

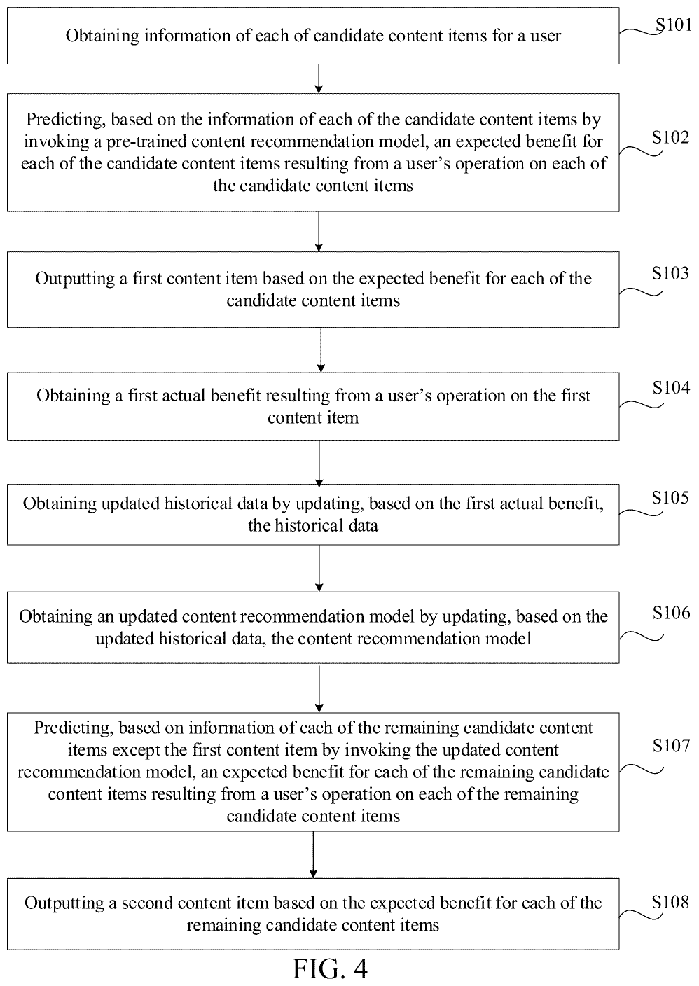

It should be noted that, after the first content item is received and a corresponding operation is performed on the received first content item, a result of the operation on the first content item can be obtained. Then the content recommendation model is updated based on the result, and a second content item is recommended to the user from the remaining candidate items except the first content item in the candidate item bank based on the updated content recommendation model. This process will be described in detail at blocks S104 to S108 below. FIG. 4 is a flowchart of another content output method according to an exemplary embodiment of the present disclosure. As shown in FIG. 4, the method may further include operations at blocks S104 to S108 subsequent to the operation at block S103.

At block S104, a first actual benefit resulting from a user's operation on the first content item is obtained.

The first actual benefit includes a result of the first content item, a correctness benefit, and an incorrectness benefit when the first content item is answer by the user. The result includes answering the first content item correctly or incorrectly. When the user answers the first content item correctly, it may be regarded as that the user has mastered a certain knowledge point of the first content item, and when the user answers the first content item incorrectly, it may be regarded as that the user has not mastered the certain knowledge point of the first content item. At the same time, the operating duration for the user to answer the first content item is also recorded to calculate the speed at which the question is answered by the user.

At block S105, updated historical data is obtained by updating, based on the first actual benefit, the historical data.

The historical data is updated based on the first actual benefit. That is, the actual benefit, the information of the historical content item, and the capability attribute information of the user are updated after the user's operation on the content item. For example, the existing ability of the user, the speed of answering the question, and the correctness benefit and the incorrectness benefit for the content item when the content item is answer by the user are updated.

At block S106, an updated content recommendation model is obtaining by updating, based on the updated historical data, the content recommendation model.

At block S107, an expected benefit for each of the remaining candidate content items except the first content item resulting from a user's operation on the remaining candidate content item is predicted based on information of each of the remaining candidate content items by invoking the updated content recommendation model.

In this operation, the method for predicting the expected benefit resulting from the user's operation on each of the remaining candidate content items is the same as that in the previous embodiment. That is, the expected benefit for the candidate question is calculated based on the correctness probability, the correctness benefit, the incorrectness probability, and the incorrectness benefit for the content question when the content question is answer by the user, and thus the detailed description thereof will be omitted herein.

At block S108, a second content item is output based on the expected benefit for each of the remaining candidate content items.

In this operation, the second content item may be output to the terminal corresponding to the user to recommend the second content item to the user. Therefore, the candidate content item with the greatest expected benefit can be recommended to the user as the second content item. The expected benefit rate of each of the remaining candidate content items for the user may also be predicted at the same time, and then the candidate content item with the greatest expected benefit rate can be recommended to the user as the second content item.

The content output method according to the embodiments of the present disclosure includes: obtaining the information of each of the candidate content items for the user; predicting, based on the information of each of the candidate content items by invoking the pre-trained content recommendation model, the expected benefit for each of the candidate content items resulting from the user's operation on each of the candidate content items, in which the pre-trained content recommendation model is trained the historical data of the user, and the historical data includes the actual benefit resulting from the user's operation on a historical content item, the information of the historical content item, and the capability attribute information of the user; and outputting the first content item based on the expected benefit for each of the candidate content items. When recommending content items to the user, the historical benefit for different users to each content item and the attribute of each content item are considered, the most suitable learning items are recommended to different users, which can maximize learning effect or learning efficiency and the knowledge level of the users in the shortest possible time.

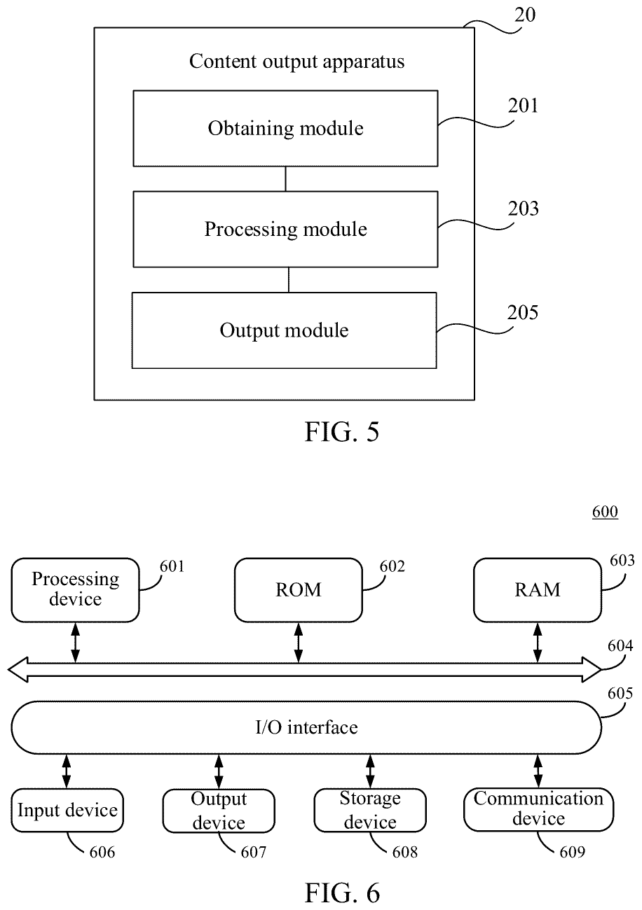

FIG. 5 is a block diagram of a content output apparatus according to an exemplary embodiment of the present disclosure. Referring to FIG. 5 an apparatus 20 includes an obtaining module 201, a processing module 203 and an output module 205.

The obtaining module 201 is configured to obtain information of each of candidate content items for a user.

The processing module 203 is configured to predict, based on the information of each of the candidate content items by invoking a pre-trained content recommendation model, an expected benefit for each of the candidate content items resulting from a user's operation on each of the candidate content items. The pre-trained content recommendation model is trained historical data of the user, and the historical data includes an actual benefit resulting from a user's operation on a historical content item, information of the historical content item, and capability attribute information of the user.

The output module 205 is configured to output a first content item based on the expected benefit for each of the candidate content items.

In some embodiments, the obtaining module 201 is further configured to obtain a first actual benefit resulting from a user's operation on the first content item.

The processing module 203 is further configured to: obtain updated historical data by updating, based on the first actual benefit, the historical data; obtain an updated content recommendation model by updating, based on the updated historical data, the content recommendation model; and predict, based on information of each of the remaining candidate content items except the first content item by invoking the updated content recommendation model, an expected benefit for each of the remaining candidate content items resulting from a user's operation on each of the remaining candidate content items.

The output module 205 is further configured to output a second content item based on the expected benefit for each of the remaining candidate content items.

In some embodiments, the processing module 203 is further configured to predict, based on the information of the candidate question by means of the content recommendation model, a correctness probability, a correctness benefit, an incorrectness probability, and an incorrectness benefit for the user to answer the candidate question; and calculate an expected benefit for the candidate question based on the correctness probability, the correctness benefit, the incorrectness probability, and the incorrectness benefit for the user to answer the candidate question.

In some embodiments, the processing module 203 is further configured to determine a candidate content item with a greatest expected benefit among the candidate content items as the first content item.

The output module 205 is also configured to output the first content item.

In some embodiments, the obtaining module 201 is further configured to obtain an operating duration required for the user to operate each of the candidate content items.

The processing module 203 is further configured to: obtain an operating duration required for the user to operate each of the candidate content items; obtain an expected benefit rate of each of the candidate content items based on the expected benefit for each of the candidate content items and the operating duration for each of the candidate content items; and determine a candidate content item with a greatest expected benefit rate among the candidate content item as the first content item.

The output module 205 is also configured to output the first content item.

Reference is now made to FIG. 6, which is a schematic structural diagram showing a structure of an electronic device 600 (e.g., the terminal or the server in FIG. 1) adapted to implement the embodiments of the present disclosure. The terminal device according to the embodiment of the present disclosure may include, but not limited to, a mobile terminal such as a mobile phone, a laptop computer, a digital broadcast receiver, a PDA, a tablet computer or PAD, a Portable Multimedia Player (PMP), or a vehicle-mounted terminal (e.g., a vehicle-mounted navigation terminal), or a fixed terminal such as a digital TV, a desktop computer, etc. The electronic device illustrated in FIG. 5 is exemplary merely, and should not be construed as limiting the function and scope of use of the embodiments of the present disclosure.

As illustrated in FIG. 6, the electronic device 600 may include a processing device (such as a central processor, a graphics processor, etc.) 601, which may perform various appropriate actions and processes in accordance with programs stored in a Read-Only Memory (ROM) 602 or loaded from a storage device 608 into a Random Access Memory (RAM) 603. In the RAM 603, various programs and data required for operation of the electronic device 600 may also be stored. The processing device 601, the ROM 602, and the RAM 603 are connected to each other via a bus 604. An Input/Output (I/O) interface 605 is also connected to the bus 604.

Generally, the following devices may be connected to the I/O interface 605: an input device 606 including, for example, a touch screen, a touch pad, a keyboard, a mouse, a camera, a microphone, an accelerometer, a gyroscope, etc.; an output device 607 including, for example, a Liquid Crystal Display (LCD), a speaker, an oscillator, etc.; the storage device 608 including, for example, a magnetic tape or a hard disk; and a communication device 609. The communication device 609 may allow the electronic device 600 to perform wireless or wired communication with other devices for data exchange. Although FIG. 6 illustrates the electronic device 600 having various devices, it will be appreciated that it is not necessary to implement or provide all the illustrated devices. In some embodiments, more or fewer devices may be implemented or provided.

According to an embodiment of the present disclosure, the processes described above with reference to the flowcharts may be implemented as computer software programs. For example, an embodiment of the present disclosure includes a computer program product, which includes a computer program carried on a non-transitory computer-readable medium. The computer program includes program codes are used for implementing the method illustrated in any of the flowcharts. In these embodiments, the computer program may be downloaded and installed from a network through the communication device 609, or installed from the storage device 608 or the ROM 602. When the computer program is executed by the processing device 601, the above-mentioned functions defined in the methods according to the embodiments of the present disclosure are performed.

It should be noted that in the present disclosure, the above-mentioned computer-readable medium may be a computer-readable signal medium or a computer-readable storage medium or any combination thereof. The computer-readable storage medium may be, but not limited to, for example, an electrical, magnetic, optical, electromagnetic, infrared, or semiconductor system, apparatus, or device, or any combination thereof. More specific examples of the computer-readable storage medium may include, but not limited to: an electrical connection having one or more wires, a portable computer disk, a hard disk, a RAM, a ROM, an Electrical Programmable Read-Only Memory (EPROM) or a flash memory, an optical fiber, a Compact Disc ROM (CD-ROM), an optical memory device, a magnetic memory device, or any suitable combination thereof. In the present disclosure, the computer-readable storage medium may be any tangible medium including or storing programs, which may be used by or used with an instruction execution system, apparatus, or device. However, in the present disclosure, the computer-readable signal medium may include a data signal propagated in a baseband or as a part of a carrier that carries computer-readable program codes. Such propagated data signal may be in various forms, including but not limited to an electromagnetic signal, an optical signal, or any suitable combination thereof. The computer-readable signal medium may be any computer-readable medium other than the computer-readable storage medium, which may transmit, propagate, or transfer programs used by or used with an instruction execution system, apparatus or device. The program codes contained on the computer-readable medium may be transmitted via any appropriate medium, including but not limited to electric cable, optical cable, Radio Frequency (RF), or any suitable combination thereof.

In some embodiments, the client and the server may communicate with each other using any well-known or future-developed network protocol, such as HTTP (HyperText Transfer Protocol), and may be in communication interconnection with digital data in any form or medium (e.g., a communication network). Examples of communication networks include a Local Area Network (“LAN”), a Wide Area Network (“WAN”), an Internet work (e.g., the Internet), and an end-to-end network (e.g., ad hoc end-to-end network), as well as any well-known or future-developed network.

The above computer-readable medium may be included in the above electronic device; or may be standalone without being assembled into the electronic device.

The above computer-readable medium may carry one or more programs which, when executed by the electronic device, cause the terminal device to: obtain information of each of candidate content items for a user; predict, based on the information of each of the candidate content items by invoking a pre-trained content recommendation model, an expected benefit for each of the candidate content items resulting from a user's operation on each of the candidate content items, in which the pre-trained content recommendation model is trained by historical data of the user, and the historical data incudes an actual benefit resulting from a user's operation on a historical content item, information of the historical content item, and capability attribute information of the user; and output a first content item based on the expected benefit for each of the candidate content items.

The computer program codes for implementing the operations of the present disclosure may be written in one or more programming languages or any combination thereof. The programming languages may include, but not limited to, object-oriented programming languages, such as Java, Smalltalk, or C++, as well as conventional procedure-oriented programming languages, such as “C” language or similar programming languages. The program codes may be executed completely on a user computer, partly on the user computer, as a standalone software package, partly on the user computer and partly on a remote computer, or completely on the remote computer or server. In a case where the remote computer is involved, the remote computer may be connected to the user computer through any types of network, including a Local Area Network (LAN) or a Wide Area Network (WAN), or to an external computer (e.g., over the Internet by using an Internet service provider).

The flowcharts and block diagrams in the figures illustrate architectures, functions, and operations of possible implementations of systems, methods and computer program products according to various embodiments of the present disclosure. In this regard, each block in the flowcharts or block diagrams may represent a module, a program segment, or a part of codes. The module, program segment, or part of codes may contain one or more executable instructions for implementing a specified logical function. It is also to be noted that, in some alternative implementations, functions showed in blocks may occur in a different order from the order shown in the figures. For example, two blocks illustrated in succession may actually be executed substantially in parallel with each other, or sometimes even in a reverse order, depending on functions involved. It is also to be noted that each block in the block diagrams and/or flowcharts, or any combination of the blocks in the block diagrams and/or flowcharts, may be implemented using a dedicated hardware-based system that is configured to perform specified functions or operations or using a combination of dedicated hardware and computer instructions.

Modules involved and described in the embodiments of the present disclosure may be implemented in software or hardware. Here, a name of a module does not constitute a limitation on the unit itself under certain circumstances.

The functions described above may be performed, at least in part, by one or more hardware logic components. For example, without limitation, exemplary types of suitable hardware logic components include a Field Programmable Gate Array (FPGA), an Application Specific Integrated Circuit (ASIC), an Application Specific Standard Product (ASSP), a System on Chip (SOC), a Complex Programmable Logic Device (CPLD), and the like.

In the context of the present disclosure, a machine-readable medium may be a tangible medium, which may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of a machine-readable storage medium would include an electrical connection having one or more wires, a portable computer disk, a hard disk, a RAM, a ROM, an EPROM or a flash memory, an optical fiber, a CD-ROM, an optical memory device, a magnetic memory device, or any suitable combination thereof.

According to one or more embodiments of the present disclosure, Example 1 is to provide a content output method including: obtaining information of each of candidate content items for a user; predicting, based on the information of each of the candidate content items by invoking a pre-trained content recommendation model, an expected benefit for each of the candidate content items resulting from a user's operation on each of the candidate content items, in which the pre-trained content recommendation model is trained by historical data of the user, and the historical data includes an actual benefit resulting from a user's operation on a historical content item, information of the historical content item, and capability attribute information of the user; and outputting a first content item based on the expected benefit for each of the candidate content items.

According to one or more embodiments of the present disclosure, Example 2 is to provide the method of Example 1, and the method further includes: obtaining a first actual benefit resulting from a user's operation on the first content item; obtaining updated historical data by updating, based on the first actual benefit, the historical data; obtaining an updated content recommendation model by updating, based on the updated historical data, the content recommendation model; predicting, based on information of each of remaining candidate content items except the first content item by invoking the updated content recommendation model, an expected benefit for each of the remaining candidate content items resulting from a user's operation on each of the remaining candidate content items; and outputting a second content item based on the expected benefit for each of the remaining candidate content items.

According to one or more embodiments of the present disclosure, Example 3 is to provide the method of Example 1, the information of the candidate content item is information of a candidate question, the information of the candidate question comprising question difficulty and a predetermined question benefit, the predetermined question benefit comprising a predetermined correctness benefit and a predetermined incorrectness benefit. The predicting, based on the information of each of the candidate content items by invoking the pre-trained content recommendation model, the expected benefit for each of the candidate content items resulting from the user's operation on each of the candidate content items includes: predicting, based on the information of the candidate question by means of the content recommendation model, a correctness probability, a correctness benefit, an incorrectness probability, and an incorrectness benefit for the user to answering the candidate question; and calculating an expected benefit for the candidate question based on the correctness probability, the correctness benefit, the incorrectness probability, and the incorrectness benefit for the user to answer the candidate question.

According to one or more embodiments of the present disclosure, Example 4 is to provide the method of Example 1, the outputting the first content item based on the expected benefit for each of the candidate content items incudes: determining a candidate content item with a greatest expected benefit among the candidate content items as the first content item; and outputting the first content item.

According to one or more embodiments of the present disclosure, Example 5 is to provide the method of Example 1, the recommending the first content item to the user based on the expected benefit for each of the candidate content items includes: obtaining an operating duration required for operating each of the candidate content items by the user; obtaining an expected benefit rate for each of the candidate content items based on the expected benefit for each of the candidate content items and the operating duration for each of the candidate content items; determining a candidate content item with a greatest expected benefit rate among the candidate content item as the first content item; and outputting the first content item.

According to one or more embodiments of the present disclosure, Example 6 is to provide a content output apparatus including: an obtaining module configured to obtain information of each of candidate content items for a user; a processing module configured to predict, based on the information of each of the candidate content items by invoking a pre-trained content recommendation model, an expected benefit for each of the candidate content items resulting from a user's operation on each of the candidate content items, in which the pre-trained content recommendation model is trained by historical data of the user, and the historical data incudes an actual benefit resulting from a user's operation on a historical content item, information of the historical content item, and capability attribute information of the user; and an output module configured to output a first content item based on the expected benefit for each of the candidate content items.

According to one or more embodiments of the present disclosure, Example 7 is to provide the apparatus of Example 6, the obtaining module is further configured to obtain a first actual benefit resulting from a user's operation on the first content item; the processing module is further configured to: obtain updated historical data by updating, based on the first actual benefit, the historical data; obtain an updated content recommendation model by updating, based on the updated historical data, the content recommendation model; and predict, based on information of each of remaining candidate content items except the first content item by invoking the updated content recommendation model, an expected benefit for each of the remaining candidate content items resulting from a user's operation on each of the remaining candidate content items; and the output module is further configured to output a second content item based on the expected benefit for each of the remaining candidate content items.

According to one or more embodiments of the present disclosure, Example 8 is to provide the apparatus of Example 6, the information of the candidate content item is information of a candidate question, the information of the candidate question comprising question difficulty and a predetermined question benefit, the predetermined question benefit comprising a predetermined correctness benefit and a predetermined incorrectness benefit. The processing module is further configured to: predict, based on the information of the candidate question by means of the content recommendation model, a correctness probability, a correctness benefit, an incorrectness probability, and an incorrectness benefit for the user to answer the candidate question; and calculate an expected benefit for the candidate question based on the correctness probability, the correctness benefit, the incorrectness probability, and the incorrectness benefit for the user to answer the candidate question.

According to one or more embodiments of the present disclosure, Example 9 is to provide a computer-readable medium, having a computer program stored thereon, in which the computer program, when executed by a processor, implements operations of the content output method as described in the above embodiments.

According to one or more embodiments of the present disclosure, Example 10 is to provide an electronic device including a memory having a computer program stored thereon; and a processor configured to execute the computer program stored on the memory to implement operations of the content output method as described in the above embodiments.

The above description is merely intended to explain the embodiments of the present disclosure and the employed principles of technology. It will be appreciated by those skilled in the art that the scope of the present disclosure herein is not limited to the technical solutions formed by the specific combinations of the above technical features, and should also encompass other technical solutions formed by any other combinations of features described above or equivalents thereof without departing from the above concepts of the present disclosure. For example, the above features and the technical features disclosed in the present disclosure having similar, but not limited to, functions are replaced with each other to form the technical solution.

In addition, although the operations are depicted in a particular order, this should not be construed as requiring the operations to be performed in the particular order shown or in a sequential order. Under certain circumstances, multitasking and parallel processing may be beneficial. Likewise, although several specific implementation details are included in the above discussion, these should not be construed as limiting the scope of the present disclosure. Certain features described in the context of individual embodiments may also be implemented in combination in a single embodiment. Conversely, the various features described in the context of a single embodiment may also be implemented in a plurality of embodiments individually or in any suitable sub-combination.

Although the subject matter has been described in language specific to structural features and/or methodological logical actions, it should be understood that the subject matter defined in the appended claims is not necessarily limited to the particular features or actions described above. Rather, the particular features and actions described above are merely exemplary forms of implementing the claims. With regard to the device in the above embodiments, specific manners of operations of respective modules have been described in detail in the method embodiments, which will not be described in detail herein.

1. A content output method, comprising:
obtaining information of each of candidate content items for a user;
predicting, based on the information of each of the candidate content items by invoking a pre-trained content recommendation model, an expected benefit for each of the candidate content items resulting from a user's operation on each of the candidate content items, the pre-trained content recommendation model being trained by historical data of the user, and the historical data comprising an actual benefit resulting from a user's operation on a historical content item, information of the historical content item, and capability attribute information of the user; and
outputting a first content item based on the expected benefit for each of the candidate content items.

2. The method according to claim 1, further comprising:
obtaining a first actual benefit resulting from a user's operation on the first content item;
obtaining updated historical data by updating, based on the first actual benefit, the historical data;
obtaining an updated content recommendation model by updating, based on the updated historical data, the content recommendation model;
predicting, based on information of each of remaining candidate content items except the first content item by invoking the updated content recommendation model, an expected benefit for each of the remaining candidate content items resulting from a user's operation on each of the remaining candidate content items; and
outputting a second content item based on the expected benefit for each of the remaining candidate content items.

3. The method according to claim 1, wherein:
the information of the candidate content item is information of a candidate question, the information of the candidate question comprising question difficulty and a predetermined question benefit, the predetermined question benefit comprising a predetermined correctness benefit and a predetermined incorrectness benefit,
said predicting, based on the information of each of the candidate content items by invoking the pre-trained content recommendation model, the expected benefit for each of the candidate content items resulting from the user's operation on each of the candidate content items comprises:
predicting, based on the information of the candidate question by means of the content recommendation model, a correctness probability, a correctness benefit, an incorrectness probability, and an incorrectness benefit for the user to answering the candidate question; and
calculating an expected benefit for the candidate question based on the correctness probability, the correctness benefit, the incorrectness probability, and the incorrectness benefit for the user to answer the candidate question.

4. The method according to claim 1, wherein said outputting the first content item based on the expected benefit for each of the candidate content items comprises:
determining a candidate content item with a greatest expected benefit among the candidate content items as the first content item; and
outputting the first content item.

5. The method according to claim 1, wherein, wherein said outputting the first content item to the user based on the expected benefit for each of the candidate content items comprises:
obtaining an operating duration required for operating each of the candidate content items by the user;
obtaining an expected benefit rate for each of the candidate content items based on the expected benefit for each of the candidate content items and the operating duration for each of the candidate content items;
determining a candidate content item with a greatest expected benefit rate among the candidate content item as the first content item; and
outputting the first content item.

6. A content output apparatus, comprising:
an obtaining module configured to obtain information of each of candidate content items for a user;
a processing module configured to predict, based on the information of each of the candidate content items by invoking a pre-trained content recommendation model, an expected benefit for each of the candidate content items resulting from a user's operation on each of the candidate content items, the pre-trained content recommendation model being trained by historical data of the user, and the historical data comprising an actual benefit resulting from a user's operation on a historical content item, information of the historical content item, and capability attribute information of the user; and
an output module configured to output a first content item based on the expected benefit for each of the candidate content items.

7. The content output apparatus according to claim 6, wherein:
the obtaining module is further configured to obtain a first actual benefit resulting from a user's operation on the first content item;
the processing module is further configured to: obtain updated historical data by updating, based on the first actual benefit, the historical data; obtain an updated content recommendation model by updating, based on the updated historical data, the content recommendation model; and predict, based on information of each of remaining candidate content items except the first content item by invoking the updated content recommendation model, an expected benefit for each of the remaining candidate content items resulting from a user's operation on each of the remaining candidate content items; and
the output module is further configured to output a second content item based on the expected benefit for each of the remaining candidate content items.

8. The content output apparatus according to claim 6, wherein:
the information of the candidate content item is information of a candidate question, the information of the candidate question comprising question difficulty and a predetermined question benefit, the predetermined question benefit comprising a predetermined correctness benefit and a predetermined incorrectness benefit; and
the processing module is further configured to: predict, based on the information of the candidate question by means of the content recommendation model, a correctness probability, a correctness benefit, an incorrectness probability, and an incorrectness benefit for the user to answer the candidate question; and calculate an expected benefit for the candidate question based on the correctness probability, the correctness benefit, the incorrectness probability, and the incorrectness benefit for the user to answer the candidate question.

9. A computer-readable medium, having a computer program stored thereon, wherein the computer program, when executed by a processor causes the processor to:
obtain information of each of candidate content items for a user;
predict, based on the information of each of the candidate content items by invoking a pre-trained content recommendation model, an expected benefit for each of the candidate content items resulting from a user's operation on each of the candidate content items, the pre-trained content recommendation model being trained by historical data of the user, and the historical data comprising an actual benefit resulting from a user's operation on a historical content item, information of the historical content item, and capability attribute information of the user; and
output a first content item based on the expected benefit for each of the candidate content items.

10. An electronic device, comprising:
a memory having a computer program stored thereon; and
a processor configured to execute the computer program stored on the memory to implement the content output method according to claim 1.

11. The content output apparatus according to claim 6, wherein:
the processing module is further configured to determine a candidate content item with a greatest expected benefit among the candidate content items as the first content item; and
the output module is further configured to output the first content item.

12. The content output apparatus according to claim 6, wherein:
the obtaining module is further configured to obtain an operating duration required for operating each of the candidate content items by the user;
the processing module is further configured to: obtain an expected benefit rate for each of the candidate content items based on the expected benefit for each of the candidate content items and the operating duration for each of the candidate content items; and determine a candidate content item with a greatest expected benefit rate among the candidate content item as the first content item; and
the output module is further configured to output the first content item.

13. The computer-readable medium according to claim 9, wherein the computer program, when executed by the processor, further causes the processor to:
obtain a first actual benefit resulting from a user's operation on the first content item;
obtain updated historical data by updating, based on the first actual benefit, the historical data;
obtain an updated content recommendation model by updating, based on the updated historical data, the content recommendation model;
predict, based on information of each of remaining candidate content items except the first content item by invoking the updated content recommendation model, an expected benefit for each of the remaining candidate content items resulting from a user's operation on each of the remaining candidate content items; and
output a second content item based on the expected benefit for each of the remaining candidate content items.

14. The computer-readable medium according to claim 9, wherein:
the information of the candidate content item is information of a candidate question, the information of the candidate question comprising question difficulty and a predetermined question benefit, the predetermined question benefit comprising a predetermined correctness benefit and a predetermined incorrectness benefit,
the computer program, when executed by the processor, further causes the processor to:
predict, based on the information of the candidate question by means of the content recommendation model, a correctness probability, a correctness benefit, an incorrectness probability, and an incorrectness benefit for the user to answering the candidate question; and
calculate an expected benefit for the candidate question based on the correctness probability, the correctness benefit, the incorrectness probability, and the incorrectness benefit for the user to answer the candidate question.

15. The computer-readable medium according to claim 9, wherein the computer program, when executed by the processor, further causes the processor to:
determine a candidate content item with a greatest expected benefit among the candidate content items as the first content item; and
output the first content item.

16. The computer-readable medium according to claim 1, wherein the computer program, when executed by the processor, further causes the processor to:
obtain an operating duration required for operating each of the candidate content items by the user;
obtain an expected benefit rate for each of the candidate content items based on the expected benefit for each of the candidate content items and the operating duration for each of the candidate content items;
determine a candidate content item with a greatest expected benefit rate among the candidate content item as the first content item; and
output the first content item.

17. The electronic device according to claim 10, wherein the processor is further configured to execute the computer program stored on the memory to:
obtain a first actual benefit resulting from a user's operation on the first content item;
obtain updated historical data by updating, based on the first actual benefit, the historical data;
obtain an updated content recommendation model by updating, based on the updated historical data, the content recommendation model;
predict, based on information of each of remaining candidate content items except the first content item by invoking the updated content recommendation model, an expected benefit for each of the remaining candidate content items resulting from a user's operation on each of the remaining candidate content items; and
output a second content item based on the expected benefit for each of the remaining candidate content items.

18. The electronic device according to claim 10, wherein:
the information of the candidate content item is information of a candidate question, the information of the candidate question comprising question difficulty and a predetermined question benefit, the predetermined question benefit comprising a predetermined correctness benefit and a predetermined incorrectness benefit,
said predicting, based on the information of each of the candidate content items by invoking the pre-trained content recommendation model, the expected benefit for each of the candidate content items resulting from the user's operation on each of the candidate content items comprises:
predicting, based on the information of the candidate question by means of the content recommendation model, a correctness probability, a correctness benefit, an incorrectness probability, and an incorrectness benefit for the user to answering the candidate question; and
calculating an expected benefit for the candidate question based on the correctness probability, the correctness benefit, the incorrectness probability, and the incorrectness benefit for the user to answer the candidate question.

19. The electronic device according to claim 10, wherein said outputting the first content item based on the expected benefit for each of the candidate content items comprises:
determining a candidate content item with a greatest expected benefit among the candidate content items as the first content item; and
outputting the first content item.

20. The electronic device according to claim 10, wherein said outputting the first content item based on the expected benefit for each of the candidate content items comprises:
obtaining an operating duration required for operating each of the candidate content items by the user;
obtaining an expected benefit rate for each of the candidate content items based on the expected benefit for each of the candidate content items and the operating duration for each of the candidate content items;
determining a candidate content item with a greatest expected benefit rate among the candidate content item as the first content item; and
outputting the first content item.
